(19) United States
(12) Patent Application Publication
(10) Pub. No.: US 2021/0245353 A1
(43) Pub. Date: Aug. 12, 2021

(54) Power Tool and Tool Accessory Data Connection

(71) Applicant: Robert Bosch GmbH, Stuttgart (DE)

(72) Inventors: Christopher R. Crowell, Chicago, IL (US); Michael Crowe, Streamwood, IL (US)

(21) Appl. No.: 16/972,854

(22) PCT Filed: Jun. 25, 2019
(86) PCT No.: PCT/EP2019/066903

§ 371 Date: Dec. 7, 2020

Related U.S. Application Data
(60) Provisional application No. 62/691,154, filed on Jun. 28, 2018.

(51) Int. Cl. B25F 5/00; B23D 61/00

(52) U.S. Cl. CPC B25F 5/00; B23B 2231/10; B23D 61/006

(57) ABSTRACT

A power tool system includes a portable power tool having a housing, a motor with an output shaft in the housing, a tool holder secured on the output, and a data reader. The system also includes a power tool accessory configured to be retained by the tool holder that has a data storage device having data stored thereon. The data reader is configured to access the data stored on the data storage device when the power tool accessory is retained by the tool holder.

### CROSS-REFERENCE TO RELATED APPLICATIONS

This application claims priority to U.S. Provisional Application Ser. No. 62/691,154 entitled “POWER TOOL AND TOOL ACCESSORY DATA CONNECTION” by Crowell et al., filed Jun. 28, 2018, the disclosure of which is hereby incorporated herein by reference in its entirety.

### TECHNICAL FIELD

The present disclosure relates generally to power tools and more particularly to accessory tools for use with power tools.

### BACKGROUND

In general, rotary power tools are light-weight, handheld power tools capable of being equipped with a variety of accessory tools and attachments, such as cutting blades, sanding discs, grinding tools, and many others. These types of tools typically include a generally cylindrically-shaped main body that serves as an enclosure for an electric motor as well as a hand grip for the tool. The electric motor drives an output shaft to rotate at high speeds. The output shaft is equipped with an accessory attachment system that enables various accessory tools to be releasably secured to the power tool.

Accessory attachment systems for rotary power tools typically include a collet configured to grip the shank of an accessory tool. When attached to the rotary tool, the collet holds the shank of the accessory tool in line with the axis of the output shaft so the accessory tool can be driven to rotate about the axis by the motor. As the output shaft is rotated, an accessory tool is driven to perform a particular function, such as sanding, grinding, or cutting, depending on the configuration of the accessory tool.

### SUMMARY OF THE CLAIMED SUBJECT MATTER

According to one embodiment, a power tool system includes a portable power tool having a housing, a motor with an output shaft in the housing, a tool holder secured on the output, and a data reader. The system also includes a power tool accessory configured to be retained by the tool holder that has a data storage device having data stored thereon. The data reader is configured to access the data stored on the data storage device when the power tool accessory is retained by the tool holder.

According to another embodiment, a method of operating a power tool system includes installing a power tool accessory in a tool holder of a power tool, and accessing the data stored on the data storage device with a data reader of the power tool. The power tool accessory includes a data storage device having data stored thereon. The data reader is positioned on the power tool to access the data storage device when the power tool accessory is installed in the tool holder. The method includes communicating the data from the data reader to a controller of the power tool, and adjusting settings of the power tool with the controller based on the data.

### BRIEF DESCRIPTION OF THE DRAWINGS

FIG. 1 is a perspective view of a rotary power tool having a data reader in accordance with the present disclosure.

FIG. 2 is a fragmentary perspective view of the nose portion of the power tool of FIG. 1 showing a tool accessory (having a data storage device) retained by the tool holder of the tool.

FIG. 3 is a schematic view of a body of a tool accessory, such as the tool accessory of FIG. 2, showing the data storage device embedded therein.

FIG. 4 depicts a tool accessory wherein a portion of the body in which the data storage device is embedded is formed of a different material than the rest of the body.

FIG. 5 depicts another embodiment of a tool accessory having a data storage device.

FIG. 5 is a block diagram showing the data storage device, data reader, tool controller, tool motor, and external device in accordance with the disclosure.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to a person of ordinary skill in the art to which this disclosure pertains.

This disclosure is directed to tool accessories provided with a data storage device and power tools for use with the tool accessories/attachments provided with hardware and software to be able to access data stored on the data storage device of the tool accessory. The data stored on the data storage device includes, for example, accessory tool identification information and/or setting information pertaining to the tool accessory.

The data storage on the tool accessory/attachment can be any suitable type of data storage that is capable of being accessed and read wirelessly. For example, the data storage may comprise a radio-frequency identification (RFID) tag or chip embedded into or secured onto the tool accessory/attachment. Other technologies that could be used to store and/or communicate data wirelessly include near-field communication (NFC), QR codes, bar codes, Bluetooth, Wifi, and the like.

The power tool is provided with a data reader that is configured to read the data from the data storage device on the tool accessory/attachment. The data reader includes the appropriate electronic devices, components and/or equipment necessary to read the data on the data storage device based on the technology used to implement the data storage on the tool accessory/attachment, e.g., RFID scanner, Bluetooth, QR/bar code reader, NFC reader, and the like.

This technology could be used for several benefits such as accessory/attachment tracking, state of health tracking for accessories/attachments, automatically adjusting speed/torque settings of the tool based on the specific accessory/attachment, relaying info to the user via an external device such as recommended settings, tutorials, reviews, where to buy, buy now, etc. Also this could be used as a means of automatic ordering based on the amount of run time on a tool. Based on speeds, tool life, known hazards/misuse, this could be used to send warning messages to users.

The power tool may be configured to directly use the data from the accessory/attachment. The data on the data storage of the tool accessory may also be communicated to an external device such as a cell phone, tablet, computer, smart watch, etc. The external device may receive this data from the power tool or may be configured to read the data directly from the data storage on the tool accessory.

In addition to reading the data, the power tool and/or the external device may be configured to write data back onto the storage device which is contained in the tool accessory. For example, the data storage of a tool accessory may be used to track the total amount of time the accessory has been used. The power tool and/or external device can monitor durations of use of the tool accessory and update this information in the data storage of the tool accessory.

According to one embodiment of the disclosure, a power tool system includes a portable power tool having a housing, a motor with an output shaft in the housing, a tool holder secured on the output, and a data reader. The system also includes a power tool accessory configured to be retained by the tool holder that has a data storage device having data stored thereon. The data reader is configured to access the data stored on the data storage device when the power tool accessory is retained by the tool holder.

In embodiments, the data storage device may comprise an RFID chip. In this case, the data reader comprises an RFID reader.

In embodiments, the power tool may comprise a rotary tool having a nose cap through which the output shaft of the motor extends in which case the data reader may be incorporated into the nose cap of the rotary tool. The power tool accessory for a rotary tool includes a mandrel. The data storage device may be incorporated into the mandrel. In one embodiment, a portion of the mandrel is formed of plastic, and the data storage device is arranged inside, e.g., embedded, the plastic portion of the mandrel.

In other embodiments, the power tool may comprise a cutting tool, such as a circular saw. In these embodiments, the data storage device may comprise a visual, machine-readable representation of data, such as a barcode or similar type of object, which is located on a side surface of a circular saw blade and which can be scanned by a suitable code reader. The scannable code can be applied in any suitable manner to the blade, e.g., via a sticker or printing. The data reader may be incorporated onto the housing in a position to scan the data storage device, e.g., on a side of the housing or on an inner surface of a guard facing the blade.

The power tool may include a communication device configured to transmit the data accessed from the data storage device to an external device, such as a mobile phone, a tablet, a computer, or a smart watch. The external device may include a processor and be configured to run a software application using the data from the data storage device as input. The external device, e.g., via the software application, may be configured to provide product information pertaining to the power tool accessory to a user of the external device.

In embodiments, the data stored on the data storage device may comprise settings data indicating settings for the power tool when using the power tool accessory. The controller of the power tool may be configured to adjust settings of the power tool based on the settings data.

In embodiments, the data stored on the data storage device may comprise usage data indicating an amount of use of the power tool accessory. The controller of the power tool may be configured to monitor current usage of the power tool accessory and access the data storage device to update the usage data on the data storage device with the current usage.

Referring now to the drawings, FIG. 1 depicts an embodiment of a power tool 10 which is configured to connect with an accessory tool in accordance with the present disclosure. The power tool in this embodiment is a rotary tool, and the tool accessory is a rotary tool accessory. However, the data storage and data reader described herein can be used on any sort of tool that takes an accessory or attachment such as a drill, a saw, rotary tool, oscillating tool, etc. The data storage and data reader can be incorporated into the tool accessory and the power tool, respectively, during manufacture and fabrication of the tool accessory and power tool. Alternatively, the data storage and/or the data reader may be configured to be provided as an add-on or replacement part after manufacture.

Referring to FIG. 1, the rotary tool 10 includes a generally cylindrically shaped housing 14 constructed of a rigid material such as plastic, metal, or composite materials such as a fiber reinforced polymer. The housing 14 includes a nose portion 18 and a main body portion 20. The main body portion 20 serves as the handle for the tool 10 and encloses a motor (not shown). In one embodiment, the motor comprises an electric motor configured to receive power from an AC outlet (not shown) via a power cord 28. Alternatively, electric power for the motor may be received from a rechargeable battery (not shown) connected at the base of the main body portion 20. A power button 16 is provided on the housing which controls power to the tool.

The motor has an output shaft (not shown) that is configured to be rotated by the motor. A tool holder 34 is attached to the end portion. For the power tool of FIG. 1, the tool holder 34 comprises a collet and collet nut. In other embodiments, any suitable type of tool holder may be used. A nose cap is installed onto the nose portion of the housing.

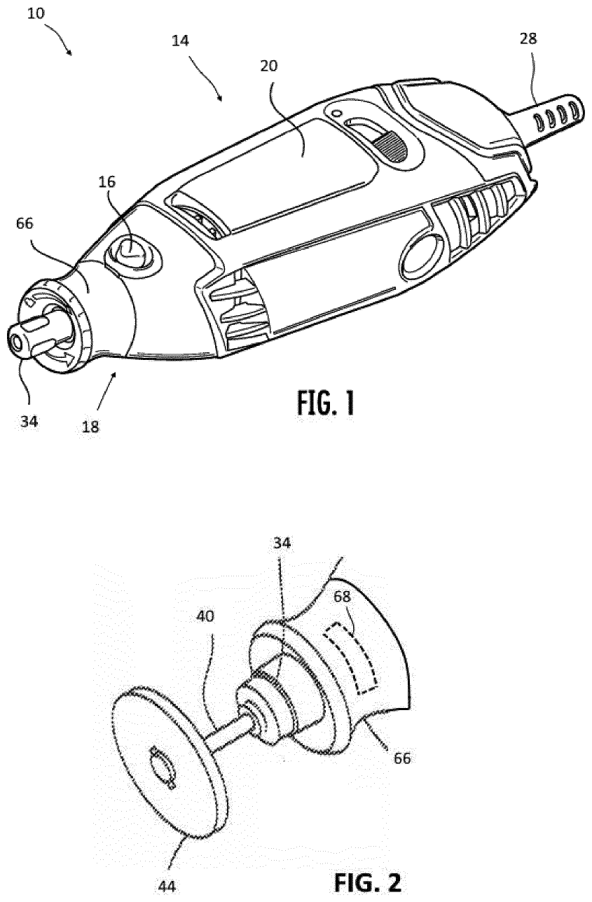

Tool holder 34 is configured to releasably retain any one of a plurality of different accessory tools, or tool bits, to the output shaft of the rotary tool 10. As is known in the art, there are a wide variety of tool accessories that can be used with the rotary tool of FIG. 1. FIG. 2 depicts one embodiment of an accessory tool 38 for use with the rotary tool 10. The accessory tool includes a mandrel 40 which is retained in the tool holder 34. In this embodiment, a disc 444, such as a sanding, cutting or grinding disc, is fastened onto the end of the mandrel 40.

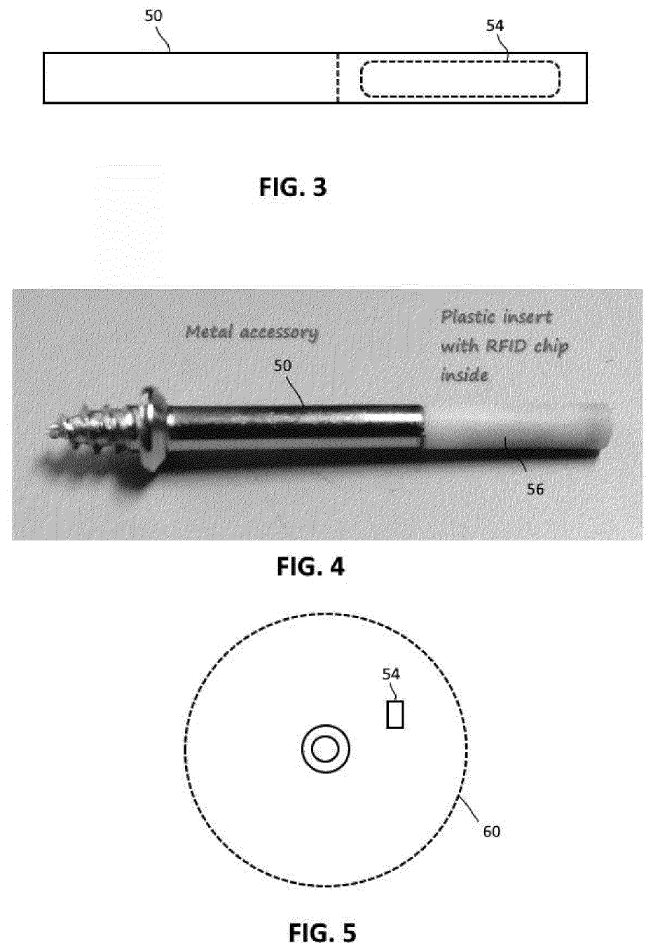

FIG. 3 depicts a body 50 of an accessory tool, such as the mandrel 44 of FIG. 2, having a data storage device 54 embedded therein. Any suitable type of data storage device may be used. In one embodiment, the data storage device 54 is a passive RFID device. In alternative embodiments, the data storage device may comprise a Bluetooth chip, NFC chip, or the like. At least the portion of the body of the tool accessory in which the data storage device is embedded is formed of a material that will allow the data storage device to be accessed. As depicted in FIG. 4, the portion 56 of the mandrel in which the data storage device 54 is embedded may be formed of a different material than the rest of the mandrel, such as plastic.

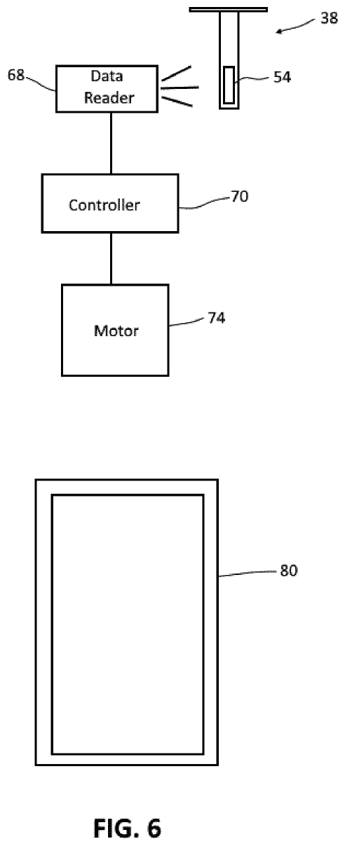

FIG. 5 depicts how a data storage device 54 can be incorporated into other types of tool accessories which may be for use with other types of power tools. The tool accessory of FIG. 4 comprises a saw blade 60. In this embodiment, the data storage device 54 comprises a RFID tag adhered to a surface of the blade 60. The data storage device in this embodiment could also be a QR code or bar code.

The data stored on the data storage device 54 includes at least a tool accessory identifier for the tool accessory. The data storage device may also include setting information for the tool accessory (e.g., speed/torque settings), web site information indicating a web site where information pertaining to the tool accessory can be found, help information (e.g., how-to instructions, videos, manuals, and the like).

The power tool 10 is provided with a data reader 68 (FIG. 2) for reading the data from the data storage device of the tool accessory. In one embodiment, the data reader 68 is incorporated into the nose cap 66 on the power tool (as indicated by the dotted lines in FIG. 2). In alternative embodiments, the data reader may be incorporated into a different part of the power tool or provided as an attachment on the power tool. The data reader 68 is compatible with whatever technology is used to implement the data storage device. In this embodiment, the data storage device is an RFID chip. Therefore, the data reader comprises an RFID reader.

The data reader 68 may be configured to read the data from the data storage device automatically when the tool accessory is inserted into the tool holder or placed in a predetermined position in relation to the nose of the power tool. The data read from the data storage device by the data reader is transferred to a controller

Referring to FIG. 6, the data reader 68 is configured to transfer the data read from the data storage device 54 of the tool accessory to a controller 70 for the power tool. The controller 70 can then use the data as the basis to adjust settings of the power tool. For example, the controller 70 may be configured to automatically adjust the settings of the power tool to recommended settings for the tool accessory. For example, the controller 70 may be configured to control the motor 74 to set the speed and/or torque to a recommended level for the tool accessory 38.

The data from the data storage device may also be transmitted to an external device 80, such as a cell phone, tablet, computer, smart watch, etc. The data may be transmitted from the power tool 10. Alternatively, the external device 80 may include a data reader that can access the data from the data storage device 54 directly.

The external device 80 can provide enhanced functionality to a user of the power tool. For example, the external device 80 can run a software application that enables information pertaining to the accessory tool and power tool to be displayed. The external device may have an internet connection which enables additional information to be downloaded from the web once the tool accessory identification information is known, such as photos, videos, tutorials, documents, etc. The software application may also provide the ability to order to buy additional tool accessories or other items.

The power tool and/or the external device may be configured to track the usage of the tool accessory. For example, the controller of the power tool and/or a processor in the external device may be configured to monitor durations of usage of the tool accessory and to maintain a running total of the overall usage of the tool accessory. This information can be stored on the power tool, the external device and/or on the data storage device of the tool accessory. The external device may be configured to monitor the amount of usage and provide warnings to user based on the amount of use.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A power tool system comprising:
a portable power tool including:
a housing;
a motor having an output shaft;
a tool holder secured on the output shaft exterior to the housing; and
a data reader;
a power tool accessory configured to be retained by the tool holder, the power tool accessory including a data storage device, the data storage device including a computer readable memory having data stored thereon;
wherein the data reader is configured to access the data stored on the data storage device when the power tool accessory is retained by the tool holder.

2. The power tool system of claim 1, wherein the data storage device comprises an RFID chip, and
wherein the data reader comprises an RFID reader.

3. The power tool system of claim 1, wherein the power tool comprises a rotary tool having a nose cap through which the output shaft of the motor extends, and
wherein the data reader is incorporated into the nose cap.

4. The power tool system of claim 3, wherein the power tool accessory includes a mandrel, and
wherein the data storage device is installed inside the mandrel.

5. The power tool system of claim 4, wherein the mandrel includes a plastic portion, and
wherein the data storage device is embedded in the plastic portion.

6. The power tool system of claim 1, the power tool further comprising:
a communication device, the communication device being configured to transmit the data accessed from the data storage device to an external device.

7. The power tool system of claim 6, wherein the external device comprises a mobile phone, a tablet, a computer, or a smart watch.

8. The power tool system of claim 7, wherein the external device includes a processor that is configured to run a software application using the data as input.

9. The power tool system of claim 7, wherein the external device is configured to provide product information to a user of the external device pertaining to the power tool accessory.

10. The power tool system of claim 1, wherein the data stored on the data storage device includes settings data indicating settings for the power tool when using the power tool accessory, and
wherein the power tool further comprises a controller configured to adjust settings of the power tool based on the settings data.

11. The power tool system of claim 9, wherein the data stored on the data storage device includes usage data indicating an amount of use of the power tool accessory, and
wherein the power tool further comprises a controller configured to monitor current usage of the power tool accessory and access the data storage device to update the usage data based on the current usage.

12. A method of operating a power tool system, the method comprising:
installing a power tool accessory in a tool holder of a power tool, the power tool accessory including a data storage device having data stored thereon;
accessing the data stored on the data storage device with a data reader of the power tool, the data reader being positioned on the power tool to access the data storage device when the power tool accessory is installed in the tool holder;
communicating the data from the data reader to a controller of the power tool; and
adjusting settings of the power tool with the controller based on the data.

13. The method of claim 12, wherein the data storage device comprises an RFID chip, and
wherein the data reader comprises an RFID reader.

14. The method of claim 13, wherein the power tool comprises a rotary tool having a nose cap through which an output shaft of a motor extends, and
wherein the data reader is incorporated into the nose cap.

15. The power tool system of claim 13, wherein the power tool accessory includes a mandrel, and
wherein the data storage device is installed inside the mandrel.

16. The power tool system of claim 15, wherein the mandrel includes a plastic portion, and
wherein the data storage device is embedded in the plastic portion.

17. The power tool system of claim 12, further comprising:
transmitting the data to an external device; and
executing a software application on the external device to provide product information pertaining to the power tool accessory to a user of the power tool system based on the data.

18. The method of claim 12, wherein the external device comprises a mobile phone, a tablet, a computer, or a smart watch.
